(19) United States
(12) Patent Application Publication
(10) Pub. No.: US 2010/0240275 A1
(43) Pub. Date: Sep. 23, 2010

(54) Dual game call device

(76) Inventors: Billy Jack Rowley, Huntsville, TX (US); Billy Ray Driggers, Riverside, TX (US)

Correspondence Address: THE MATTHEWS FIRM, 2000 BERING DRIVE, SUITE 700, HOUSTON, TX, 77057, US

(21) Appl. No.: 12/383,325

(22) Filed: Mar. 23, 2009

(51) Int. Cl. A01M 31/00

(52) U.S. Cl. 446/208

(57) ABSTRACT

A game call device and method of use for enabling production of at least two differing game calls in rapid succession is described herein. The game call device includes a housing having a first end, a second end, and an interior opening therebeween. A first sound device is disposed in the first end, and a second sound device is disposed in the second end. Each sound device has an air passage in communication with the interior opening. Air passed through the second air passage causes the first sound device to produce a game call, while air passed through the first air passage causes the second device to produce a differing game call. The dual use of each air passage as an inlet for actuating the opposing sound device, and as an exhaust opening, enables the game call device to be designed compactly, without requiring additional exhaust openings.

### FIELD

The present invention relates to a game call device usable to produce at least two differing game calls in rapid succession.

### BACKGROUND

When hunting multiple types of fowl or other wild game, a hunter typically wears a lanyard having a large number of game calls strung or otherwise attached thereon. Game call devices are also of particular use and interest to bird watchers and other naturalists for attracting and observing various animals. Each game call is configured to produce a different sound to attract a different species of animal, through vibration of reeds or bands, the passage of air across openings, similar to a whistle, or through the striking of two solid or hollow pieces against one another.

While a hunter can retain on hand a single game call for use while working a single group of birds or other game, there are times when a hunter may wish to work two different species of game simultaneously. To accomplish this, the hunter, working the first species of game using a first game call, must then stop and take time to locate a second game call appropriate for the second species of game, among a collection of numerous other game calls, which normally requires that the hunter divert his attention from his surroundings. When hunting particularly fast, small, or elusive game, such as flocks of fowl, taking one's eyes off of the game to locate a second game call can cause the hunter to lose a target. It is also common to have a second hunter present, who can carry a second game call at the ready, for producing game calls to decoy a second species of game. However, coordination with a second hunter can be inconvenient and less productive, and there are times when it is desirable to hunt multiple species of game simultaneously without relying on another individual.

Many existing game calls include manually adjustable bands, coverable openings, or other parts that can be used to vary the pitch of a produced sound to determine the optimal call for attracting an animal. However, these variations in pitch and tone are normally unsuitable for attracting a wholly different species of game. Game calls that include multiple call barrels or similar sound devices are typically bulky in design, requiring sufficient space in each individual sound device for an air inlet, vibration of the sound device, and a separate opening for exhaust of the air.

A need exists for a single game call device that is able to produce multiple differing game calls in rapid succession, without requiring a user to divert attention from nearby animals to obtain an additional game call device.

A further need exists for a game call device that is compact in design, minimizing the space required for excess airways, vibration, and exhaust.

A need also exists for a game call device that can produce multiple game calls, enabling hunters and other individuals seeking to observe wild game to carry a minimum of excess bulky game calls.

The present embodiments meet these needs.

### SUMMARY

The present invention relates to a game call device usable to produce at least two differing game calls in rapid succession. The device includes a housing having two ends, with an interior opening disposed therebetween. In an embodiment, the housing can be tubular in shape, and can be formed from wood, plastic, metal, one or more polymers, or any other durable and generally rigid material. The housing can include any number of exterior grooves and/or protrusions to facilitate gripping the device, to ornament the device, or to provide the device with a specific exterior feel to enable a user to differentiate the game call device from other devices through touch.

A first sound device is disposed in the first end of the housing member, and a second sound device is disposed in the second end of the housing member. Each sound device includes an air passage that communicates with the central opening. The air passages of the sound devices can be aligned with the longitudinal axis of the housing, and/or with one another, to facilitate airflow. In an embodiment, one or both sound devices can include a mouthpiece, a sound board, and one or more reeds, which produce a game call responsive to the passage of air between the reeds and sound board, causing the reeds and/or the sound board to vibrate. Other types of sound devices able to be actuated by the flow of air are also usable. Game calls relating to any species of animal can be produced, including mallard, goose, teal, diver, and other bird calls, predator calls, deer and elk calls, or any other type of game call.

The sound devices can be removably secured to the housing, which can include threadably securing the sound devices to the housing, locking the sound devices into place using a sealing member, such as one or more O-rings, or combinations thereof. Use of removable sound devices facilitates interchangeability of the sound devices when a need arises for a differing set of game calls.

In operation, a user can blow air into the second end of the housing, through the air passage of the second sound device, into the central opening, where the blown air can actuate the first sound device to produce a game call. The air can then be exhausted through the air passage of the first sound device as it produces a sound. Then, to produce a differing game call promptly following the first game call, the user can rotate the housing and blow air into the first end. The air travels through the first air passage into the central opening, where it actuates the second sound device, then exhausts through the air passage of the second sound device.

This configuration enables the present game call device to be constructed with a simple and extremely compact design, as the sound device to be actuated is positioned opposite the end of the housing into which air is introduced, enabling the sound devices to be oriented in the opposite direction of conventional game calls. The air passages through each sound device can be used as both air inlet and exhaust openings, enabling the bulk of the housing to be minimized. Though no additional exhaust opening is required, in an embodiment, the housing can include one or more exterior passages for communicating between the atmosphere and the interior opening. These exterior openings can be selectively covered to control the volume and/or pitch of the sound produced.

The embodiments herein thereby enable a user to produce at least two differing game calls in rapid succession, while permitting a design that minimizes bulk and weight due to the orientation of the sound devices and dual use of the air passages therein. Coupled with the possible use of interchangeable sound devices, a user can attract multiple species of game while carrying a minimum of game calling equipment.

### BRIEF DESCRIPTION OF THE DRAWINGS

In the detailed description of the embodiments presented below, reference is made to the accompanying drawings, in which:

FIG. 1 depicts a cross-sectional view of an embodiment of the present game call device.

FIGS. 2A and 2B depict cross-sectional views of sound devices usable with the game call device of FIG. 1.

FIG. 3 depicts a cross-sectional view of a housing usable with the game call device of FIG. 1.

The present embodiments are detailed below with reference to the listed Figures.

### DETAILED DESCRIPTION OF THE EMBODIMENTS

Before explaining the present embodiments in detail, it is to be understood that the embodiments are not limited to the particular descriptions and that the embodiments can be practiced or carried out in various ways.

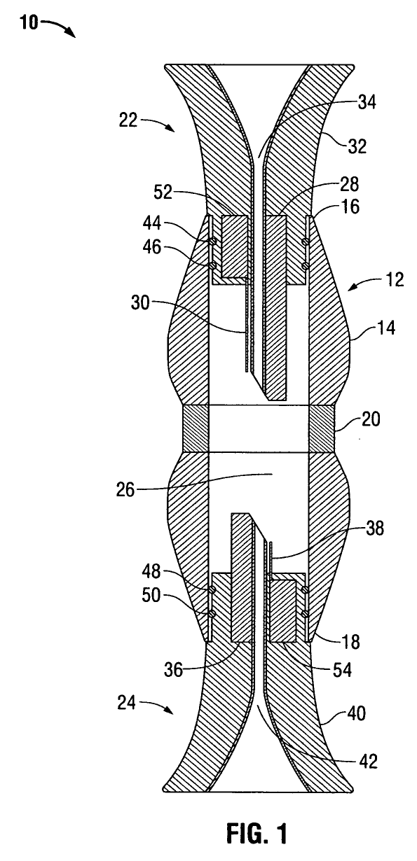

Referring now to FIG. 1, an embodiment of the present game call device is depicted. The game call device (10) is shown including a housing (12), which is depicted as a generally tubular body (14) having a first end (16) opposite a second end (18). The tubular body (14) is shown having an exterior groove (20), which is usable to facilitate gripping and/or to provide the game call device with a unique and recognizable shape.

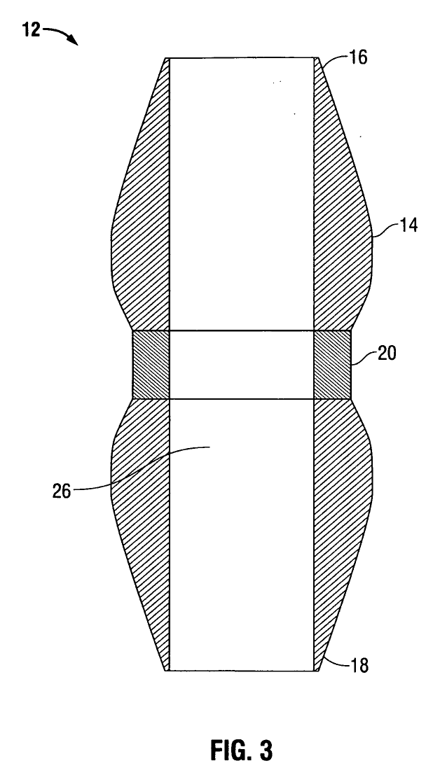

FIG. 3 depicts a cross sectional view of the housing (12), which depicts the tubular body (14) as a one-piece, double-sided barrel, having an interior space (26), defined by a bore therethrough for accommodating sound devices and enabling the passage of air. The housing (12) can have any length or diameter, as needed, to accommodate desired sound devices. For example, the tubular body (14) can include an inner bore 0.625 inches in diameter, for accommodating a duck call in one end and a speck call in the opposing end. The exterior of the tubular body (14) can include protrusions, grooves, such as groove (20), bands, or any other textural, ornamental, or functional feature for facilitating grip, enabling recognition of the game call device by touch, or providing improvements to sound quality via vibration and/or resonance. The interior of the tubular body (14) can include threads for engaging complementary threads disposed on sound devices, grooves for accommodating O-rings or other sealing members, angled or tapered faces for facilitating secure fitting of sound devices within the interior space (26), or other similar features.

Returning now to FIG. 1, FIG. 1 shows a first sound device (22) secured within the first end (16) of the housing (12). A second sound device (24) is shown secured within the second end (18) of the housing (12). The interior space (26) is thereby defined within the tubular body (14), disposed between the sound devices (22, 24). The sound devices (22, 24) can be secured within the housing (12) using threaded seals, locked into place using O-rings or similar sealing members, or force fit into position in the manner of stoppers. A first O-ring (44) and a second O-ring (46) are shown securing the first sound device (22) within the first end (16) of the housing (12). A third O-ring (48) and a fourth O-ring (50) are shown securing the second sound device (24) within the second end (18) of the housing (12). Other engagement means between the housing (12) and sound devices (22, 24) are also usable as long as a substantially airtight seal is formed between each sound device (22, 24) and the respective end (16, 18) of the housing (12).

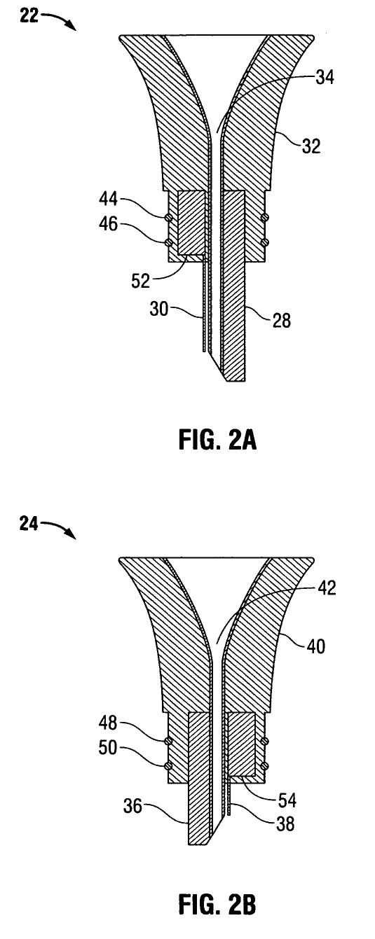

FIG. 2 depicts a cross sectional view of the sound-devices (22, 24) independent of the housing (12). With reference to FIGS. 1 and 2, the first sound device (22) is shown having a first sound board (28) and a first reed (30) configured to vibrate and produce a game call when air is blown into the housing (12) from the second end (18). A first wedge member (52), which can include a piece of cork or similar material, is used to secure the first reed (30) against the first sound board (28). The first wedge member (52) can also be usable to facilitate the securing of the first sound device (22) within the first end (16) of the housing (12). In other embodiments, use of wedge members can be omitted. The first sound device (22) is also shown having a first mouthpiece (32). A first air passage (34) is disposed through the first mouthpiece (32) and between the first sound board (28) and first reed (30).

The second sound device (24) is shown having a second sound board (36) and a second reed (38) configured to vibrate and produce a game call when air is blown into the housing (12) from the first end (16). A second wedge member (54) is shown securing the second reed (38) to the second sound board (36). The second sound device (24) is also shown having a second mouthpiece (40). A second air passage (42) is disposed through the second mouthpiece (40) and between the second sound board (36) and second reed (38).

In operation, the depicted game call device can be gripped by the tubular body (14) of the housing (12), facilitated by the exterior groove (20), and air can be blown into the first mouthpiece (32) at the first end (16) of the housing (12). The blown air travels through the first air passage (34) into the interior space (26), then to the second sound device (24), where the blown air causes the second reed (38) and/or the second sound board (36) to vibrate, producing a game call. The blown air can be exhausted through the second air passage (42) at the second end (18) of the housing (12).

The game call device can then be promptly rotated, and air can be blown into the second mouthpiece (40) at the second end (18) of the housing (12). The blown air travels through the second air passage (42) into the interior space (26), then to the first sound device (22), where the blown air causes the first reed (30) and/or the first sound board (28) to vibrate, producing a game call. The blown air can be exhausted through the first air passage (34) at the first end (16) of the housing (12).

In an embodiment, the air passages (34, 42) of the sound devices (22, 24), respectively, can be aligned with the longitudinal axis of the tubular body (14) and/or with each other, for facilitating the passage and exhaust of air through the game call device.

Thus, through the compact design depicted in FIG. 1, each sound device (22, 24) can be actuated by air blown through the opposing sound device, disposed in the opposite end of the housing (12). This design enables each air passage (34, 42) to serve the dual purpose of both an air inlet and an exhaust opening. As a result, no exterior openings in the tubular body (14) are necessary to exhaust blown air, however in an embodiment, the tubular body (14) can include one or more exterior openings for communicating between the atmosphere and the interior space (26). The exterior openings can be partially or wholly covered to modify the pitch of the game call device.

As shown in FIGS. 1 and 2, each sound board (28, 36) and each reed (30, 38) can have any composition, length, thickness, or configuration, as desired, to produce a desired game call, including use of double reed assemblies, wooden, metallic, or mylar reeds or sound boards, or other similar types of reeds and sound boards. For example, in FIGS. 1 and 2, the first reed (30) is depicted having a greater length than the second reed (38).

The depicted and described embodiments thereby enable a user to produce at least two differing game calls in rapid succession, and to produce additional game calls by interchanging removably secured sound devices within a housing. Additionally, the embodiments herein provide a minimum amount of bulk and weight due to the orientation of the sound devices, which is the inverse of conventional sound devices, due to the dual use of the air passages within the present game call device. The embodied design coupled with the interchangeability of the sound devices thereby enables a user to attract multiple species of game while carrying a minimum of game calling equipment.

While these embodiments have been described with emphasis on the embodiments, it should be understood that within the scope of the appended claims, the embodiments might be practiced other than as specifically described herein.

What is claimed is:

1. A game call device for enabling production of at least two differing game calls in rapid succession, the device comprising:
a housing comprising a first end, a second end, and an interior opening between the first end and the second end;
a first sound device disposed in the first end, wherein the first sound device comprises a first air passage in communication with the interior opening; and
a second sound device disposed in the second end, wherein the second sound device comprises a second air passage in communication with the interior opening, wherein air passed through the second air passage causes the first sound device to produce a first game call, and wherein air passed through the first air passage causes the second sound device to produce a second game call.

2. The game call device of claim 1, wherein the housing further comprises a tubular body and a longitudinal axis, and wherein the first air passage and the second air passage are disposed in alignment with the longitudinal axis.

3. The game call device of claim 1, wherein the first sound device, the second sound device, or combinations thereof, comprise a mouthpiece, a sound board, and a reed for producing a game call sound responsive to the passage of air, causing the reed, the sound board, or combinations thereof, to vibrate.

4. The game call device of claim 1, wherein first sound device, the second sound device, or combinations thereof, are threadably secured to the housing.

5. The game call device of claim 1, further comprising a first sealing member disposed between the first sound device and the housing, a second sealing member disposed between the second sound device and the housing, or combinations thereof.

6. The game call device of claim 1, wherein the housing further comprises at least one exterior passage in communication with the interior opening for communication of exhaust between the atmosphere and the interior opening.

7. The game call device of claim 1, wherein air passed through the second air passage is exhausted through the first air passage, and wherein air passed through the first air passage is exhausted through the second air passage.

8. The game call device of claim i, wherein the first sound device, the second sound device, or combinations thereof, are interchangeably disposed within the housing.

9. A method for producing of at least two differing game calls in rapid succession, the method comprising the steps of:
providing a game call device comprising a first sound device comprising a first air passage therein and a second sound device comprising a second air passage therein;
producing a first game call using the first sound device by passing air through the second air passage; and
producing a second game call using the second sound device by passing air through the first air passage.

10. The method of claim 9, wherein the step of producing the first game call further comprises exhausting air through the first air passage.

11. The method of claim 9, wherein the step of producing the second game call further comprises exhausting air through the second air passage.

12. The method of claim 9, wherein the step of producing the first game call, the step of producing the second game call, or combinations thereof, comprises vibrating a reed, a sound board, or combinations thereof.

13. The method of claim 9, wherein the step of producing the first game call, the step of producing the second game call, or combinations thereof, comprises passing the air across at least one opening in a housing containing the first sound device and the second sound device.

14. The method of claim 9, further comprising the step of exhausting air through an opening in communication with the atmosphere, wherein the opening is disposed through a housing containing the first sound device and the second sound device, and wherein the opening is disposed between the first sound device and the second sound device.

15. The method of claim 9, further comprising the step of removing the first sound device, the second sound device, or combinations thereof, from the game call device, and replacing the first sound device, the second sound device, or combinations thereof, with at least one additional sound device.

16. A game call device for enabling production of at least two differing game calls in rapid succession, the device comprising:
a tubular housing comprising a first end, a second end, a longitudinal axis, and an interior opening disposed along the longitudinal axis between the first end and the second end;
a first sound device removably disposed in the first end, wherein the first sound device comprises a first air passage in communication with the interior opening and aligned with the longitudinal axis; and
a second sound device removably disposed in the second end, wherein the second sound device comprises a second air passage in communication with the interior opening and aligned with the longitudinal axis, wherein air passed through the second air passage causes the first sound device to produce a first game call, and wherein air passed through the first air passage causes the second sound device to produce a second game call.

17. The game call device of claim 16, wherein the first sound device, the second sound device, or combinations thereof, comprise a mouthpiece, a sound board, and a reed for producing a game call sound responsive to the passage of air, causing the reed, the sound board, or combinations thereof, to vibrate.

18. The game call device of claim 16, further comprising a first sealing member disposed between the first sound device and the tubular housing, a second sealing member disposed between the second sound device and the tubular housing, or combinations thereof.

19. The game call device of claim 16, wherein the tubular housing further comprises at least one exterior passage in communication with the interior opening for communication of exhaust between the atmosphere and the interior opening.

20. The game call device of claim 1, wherein first sound device, the second sound device, or combinations thereof, are threadably secured to the tubular housing.
